(19) United States
(12) Patent Application Publication
(10) Pub. No.: US 2017/0332200 A1
(43) Pub. Date: Nov. 16, 2017

(54) RADIOCOMMUNICATION SYSTEMS, METHODS AND DEVICES

(71) Applicants: Charles A. KAIMAN, Fredericksburg, VA (US); Stephen J. LABRADOR, Fredericksburg, VA (US)

(72) Inventors: Charles A. KAIMAN, Fredericksburg, VA (US); Stephen J. LABRADOR, Fredericksburg, VA (US)

(21) Appl. No.: 15/593,625

(22) Filed: May 12, 2017

Related U.S. Application Data
(60) Provisional application No. 62/336,023, filed on May 13, 2016.

(51) Int. Cl. H04W 4/02; H04W 4/14

(52) U.S. Cl. CPC H04W 4/023; H04W 4/14; H04M 2250/10

(57) ABSTRACT

A radiocommunication system includes a first plurality of computing devices each including a first interface for entering information associated with creation of a time-sensitive, geocoded event message and for uploading the time-sensitive, geocoded event message. A central server is configured to store and process the uploaded time-sensitive, geocoded event messages received via the Internet from the first plurality of computing devices and to generate local map displays which include icons associated with the time-sensitive, geocoded event messages. A second plurality of wireless computing devices is included in the system, each of which are configured to execute an application that receives and displays one of the local map displays generated by the central server.

### RELATED APPLICATION

The present application is related to, and claims priority from U.S. Provisional Patent Application No. 62/336,023, filed May 13, 2016, entitled “RELIABLE TIME-SENSITIVE LOCATION BASED SERVICES FOR RADIOCOMMUNICATION SYSTEMS AND DEVICES,” to Charles A. Kaiman and Stephen J. Labrador., the disclosure of which is incorporated herein by reference.

### TECHNICAL FIELD

Embodiments of the subject matter disclosed herein generally relate to methods and systems for enabling provision of reliable location based services to users in radiocommunication systems and, more particularly, to location based service information which is provided with time-sensitive constraints that enhance reliability for users thereof.

### BACKGROUND

Accurately determining the geographic position of a mobile user within a wireless communication network is an ongoing challenge in wireless telecommunications development. Government mandates, such as the E-911 positioning requirements in North America, and commercial Location Based Services (LBS) demand rapid and accurate position determination for user equipment (UE). Determining a location of user equipment is frequently referred to as “positioning” in the radiocommunication art. The accurate positioning of a UE becomes more challenging when considering indoor scenarios where, for example, Assisted GPS signals are less detectable.

Several position determination methods, of varying accuracy and complexity, are known in the art. These include cell ID positioning, Round Trip Timing (RTT) positioning, Observed Time Difference of Arrival (OTDOA) positioning, Assisted Global Positioning System (A-GPS) positioning, and fingerprinting positioning. Some of these positioning techniques will now be described in more detail.

For example, Assisted GPS (A-GPS) positioning is an enhancement of the global positioning system (GPS), an exemplary architecture of which is illustrated in FIG. 1. Local GPS reference receiver networks/Global reference receiver networks collect assistance data from GPS satellites, such as ephemeris data. The assistance data, when transmitted to GPS receivers in UEs connected to the cellular communication system, enhance the performance of the UE GPS receivers. Typically, A-GPS accuracy can become as good as plus or minus ten meters without differential operation. However, this accuracy becomes worse in dense urban areas and indoors, where the sensitivity of the GPS receivers in UEs is most often not high enough for detection of the relatively weak signals which are transmitted from the GPS satellites.

Regardless of which technology is used to locate a user's mobile device, the resulting location information is available for commercial and government usage. For example, various location tracking applications (“apps”) are currently available to source a device's location to other apps, e.g., location tracking apps such as Google Latitude, Find My Friends, Nearby and Pathshare. Such location tracking apps return, e.g., the longitude, latitude and, optionally, a confidence indicator (indicating a likelihood that a device is actually within a certain area around the identified coordinates) to other apps which then use that location information in various ways. For example, local mobile search apps can use this location data to enable users to search for businesses, events, and products which are near to their current location.

An example of such a local mobile search app is Around Me. As shown in FIGS. 2(a)-2(d), the Around Me app provides a tool for users to locate local service and product providers. Once the Around Me app is launched, the user can allow the app to use his or her current location. Using this location, a user can search the area around his or her locale for a range of things, from hospitals to movie theaters, and retail stores to bars and restaurants, using a list based interface 200 displayed on a user's mobile device, an example of which is shown in FIG. 2(a). Tapping on a category in the Around Me app's interface 200, e.g., “Bars” 202, returns a list of places within that category which are local to the user's current location, e.g., list 204 shown in FIG. 2(b).

From the list interface 204 shown in FIG. 2(b), a user can find even more information about a particular establishment by tapping on a corresponding entry. For example, by tapping on the “White Horse Tavern” entry 206, the app can generate another user interface screen 208 as shown in FIG. 2(c). Therein, the establishment's address and phone number are available, as are capabilities to share the information using various social media outlets, to show a route between the user's current location and the establishment and to add the establishment as a favorite. Returning to FIG. 2(b), the user also has the option of viewing the list of entries in a map view by tapping on map button 210. This results in the app displaying a map view 212 shown in FIG. 2(d). Therein, each of the list entries from FIG. 2(b) is represented by a pin on the map 212. Tapping one of these pins brings up their details as represented by balloon box 214 in FIG. 2(d).

Apps like Around Me provide users with valuable information about their local product and service providers, which takes advantage of location data which is available from today's networks to inform a user of businesses and services that are available in his or her current location area. However such apps are also relatively static in nature, e.g., providing static information about a business like business address and phone number, and they also typically provide little more information than that which is available from web based services like Google Maps. Moreover, even the static information presented by such apps can be unreliable since the business owners aren't involved in updating the information and because it is difficult for the individual or company which maintains the local mobile search app to continuously and rigorously update a very large database of static local business information.

Accordingly, it would be desirable to create location based systems, devices, methods and software applications which overcome these and other drawbacks and problems.

### SUMMARY

According to an embodiment, a radiocommunication system includes a first plurality of computing devices each including a first interface for entering information associated with creation of a time-sensitive, geocoded event message and for uploading the time-sensitive, geocoded event message; a central server configured to store and process the time-sensitive, geocoded event messages received via the Internet from the first plurality of computing devices and to generate local map displays which include icons associated with said time-sensitive, geocoded event messages; and a second plurality of computing devices, including a plurality of wireless communication devices, each of which are configured to execute an application that receives and displays one of the local map displays generated by the central server; wherein the one of the local display maps which is displayed on a particular one of the wireless communication devices includes icons associated with the time-sensitive, geocoded event messages for events which are occurring within both a predetermined time period and within a predetermined distance of a current location of that particular one of the wireless communication devices.

According to another embodiment, a method for providing location based services to a client device includes the steps of receiving, at a server, a signal indicating that a location based service application is active on the client device; searching, on the server, a database of geocoded location based service records to determine which of the geocoded location based service records are associated with positions that are within a predetermined distance of a location of the client device; transmitting, by the server, a signal to the client device including information associated with time-sensitive messages for those geocoded location based service records which are associated with positions that are within the predetermined distance of the location of the client device, wherein the time-sensitive messages are valid only for a predetermined time period, after which they are no longer transmitted toward the client device.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 depicts a radiocommunication system;

FIGS. 2(a)-2(d) illustrate various user interface screens associated with a conventional local mobile search application;

FIG. 3 illustrates a time-sensitive, geocoded event message publication/distribution system according to an embodiment;

FIGS. 4(a) and 4(b) illustrate various user interface screens associated with a client application according to an embodiment;

FIGS. 5(a)-5(c) depict various user interface screens associated with a business application for creating a time-sensitive, geocoded event message according to an embodiment;

FIG. 6(a) is a signaling diagram according to an embodiment;

FIG. 6(b) illustrates a data packet sent via one of the signals shown in FIG. 6(a);

FIGS. 7(a)-7(c) depict various user interface screens associated with a business application for creating a time-sensitive, quantity-limited geocoded event message according to another embodiment;

FIG. 7(d) is a signaling diagram according to an embodiment;

FIG. 8 depicts various logic modules associated with an implementation of a time and/or quantity sensitive, geocoded event message publication/distribution system according to an embodiment; and

FIG. 9 is a flowchart illustrating a method according to an embodiment.

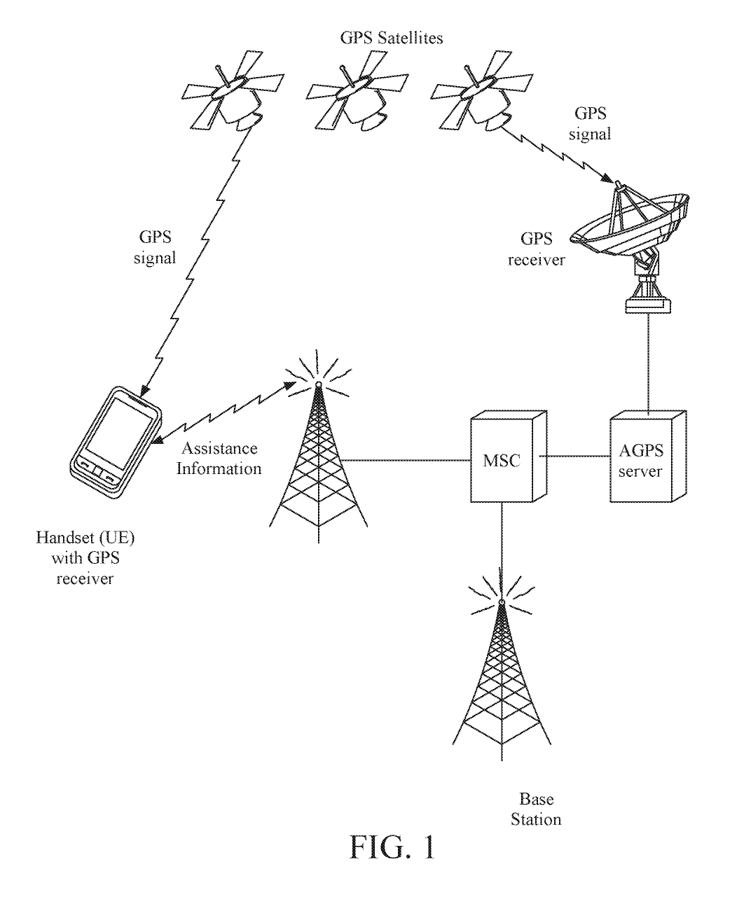

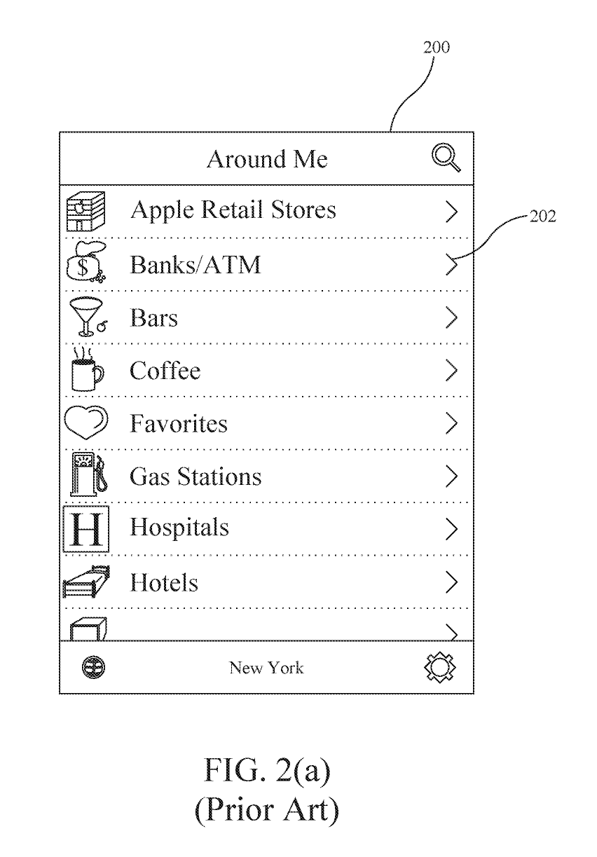

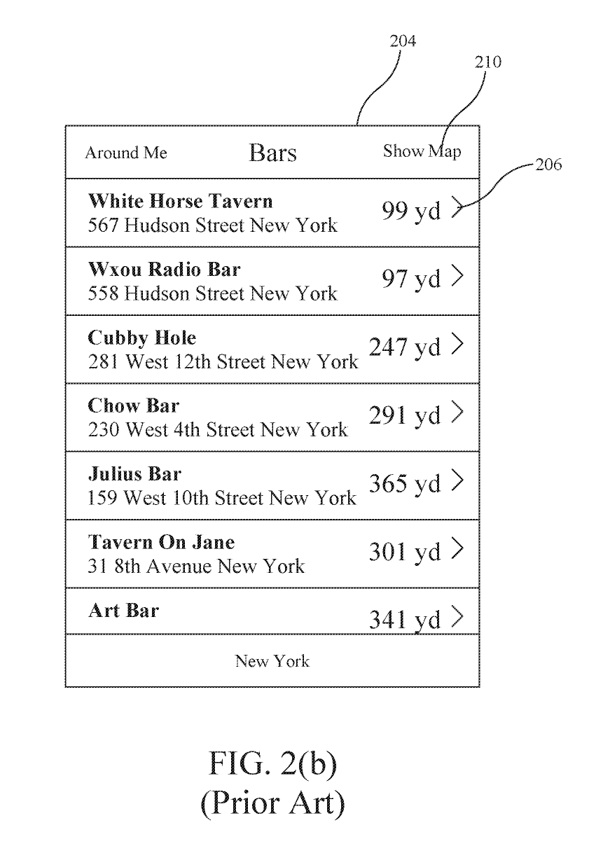

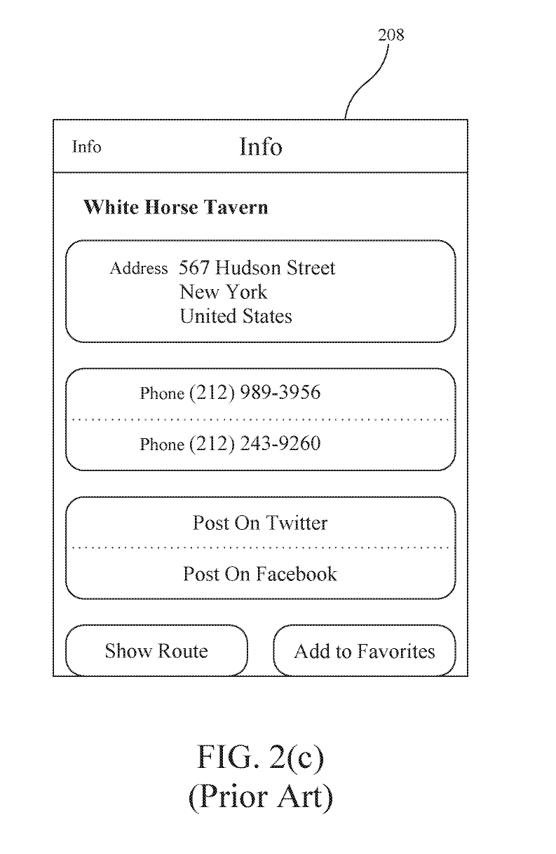

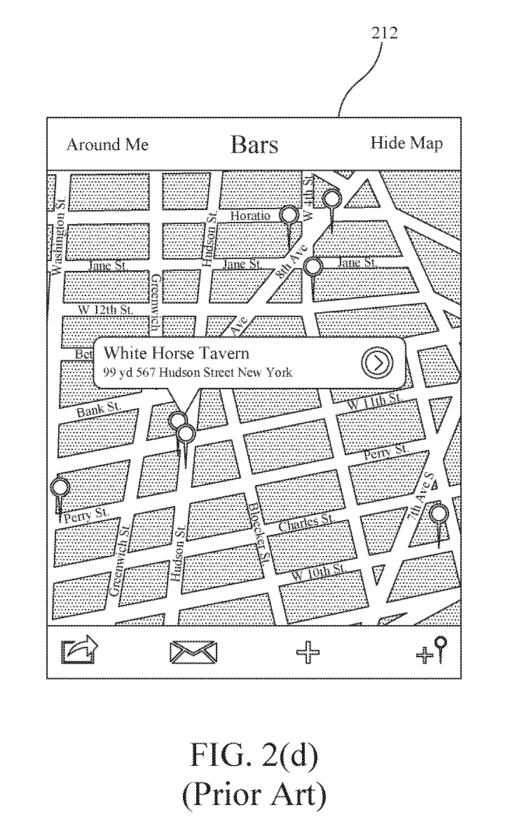

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The embodiments to be discussed next are not limited to the configurations described below, but may be extended to other arrangements as discussed later.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

As mentioned above, when implementing location based services in radiocommunication systems, it would be desirable to make the information provided to client users both more dynamic (thereby more interesting to those users) and more reliable (thereby more convenient for those users), than systems which provide only static and/or unreliable information. Embodiments described herein employ a number of techniques for implementing systems which achieve the competing objectives of reliability and providing dynamic content including, among other things, virtual sandwich boards which convey time-sensitive messages that are selectively made visible to client users on a local map interface displayed on, e.g., their portable devices.

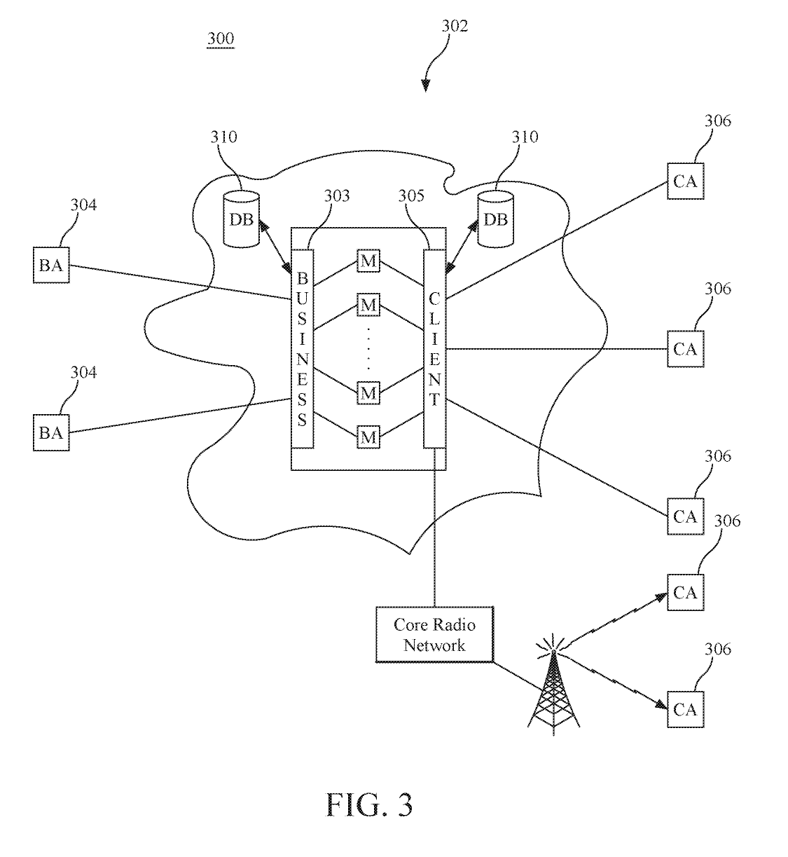

According to an embodiment, one combination of technical features used to realize these types of location based services is generally illustrated in FIG. 3. More specifically, FIG. 3 illustrates a time-sensitive, geocoded event message distribution system 300 according to an embodiment. In this context, “time-sensitive” refers to a message which has a certain validity period or expiration time. In this context, “geocoded” refers to a message which has a location associated with the message. In this context an “event message” can be a text and/or image based message associated with any event or occurrence, e.g., a sale of a product or service, public or private event information, a change in time/date notification, etc.

Central to the system 300 is a cloud-based central server 302 which provides an interface 303 toward businesses, represented by computer devices 304 and having a business app (BA) running thereon, as well as a client interface 305 toward users, represented in FIG. 3 by mobile devices 306 having client apps (CA) running thereon. In this context “businesses”, can be any type of approved organization, e.g., commercial, non-profit, religious, public service or even potentially individual activities like yard sales. According to some embodiments, the BA 304 and CA 306 can be a combined application with both business and client capabilities, while according to other embodiments they can be architected as separate apps. Herein, the reference numeral 306 is used to alternatively in this Detailed Description to refer to the client/mobile device, the client app or both the client device and the client app as will be appreciated by the context of the relevant portion of the description and, similarly, the reference numeral 304 is used to refer to the business computing device, the business app or both.

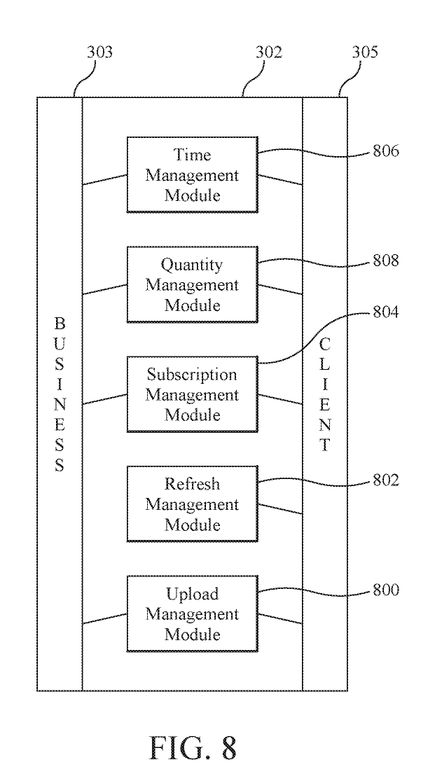

Also shown in FIG. 3 are various modules (M) which support the features and functions associated with the business and client apps and which will be described in more detail below with respect to FIG. 8. Note, however, that some of the modules M interact with both the business interface 303 and the client interface 304, e.g., in support of functions where certain data and signaling is provided from a business app 304 to one or more client apps 306 or vice versa, whereas other modules interact with only one of the business interface 303 and client interface 304, e.g., in support of functions which do not involve the transfer of information from the business side to the client side, or vice versa. In certain circumstances, and according to some embodiments, the system 300 is designed to prevent businesses from acquiring information regarding a user 306's location (and other personal information of the users) so as to safeguard users' privacy. As can be seen in FIG. 3, connections between the cloud server 302 and the client devices 306 can involve either wireline and/or wireless connections (and the same holds for the business devices 304 as well).

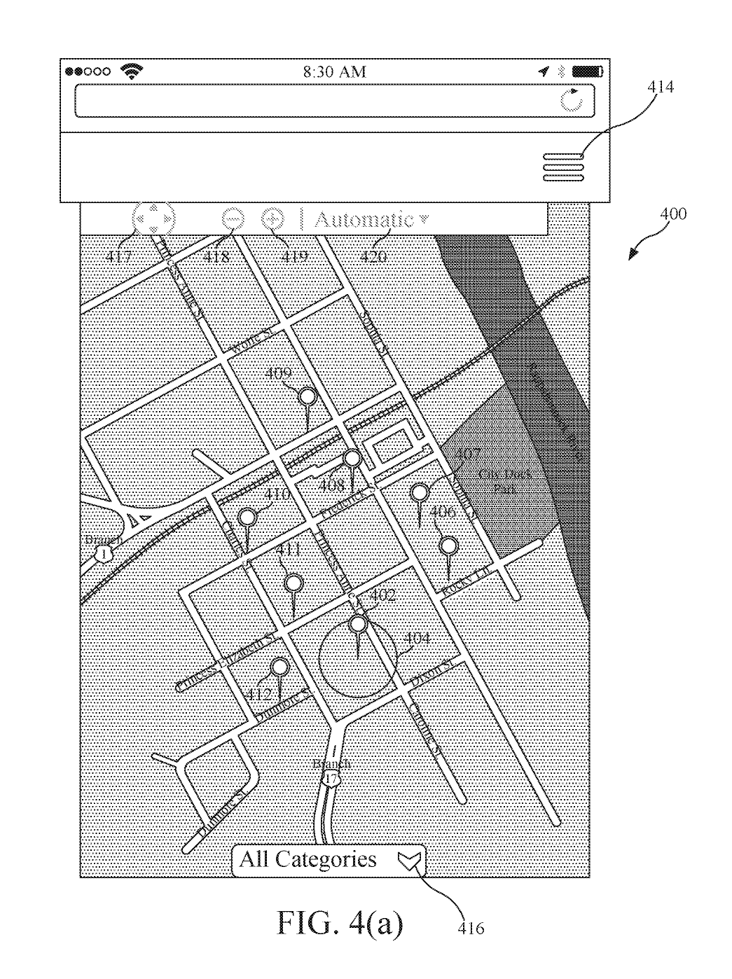

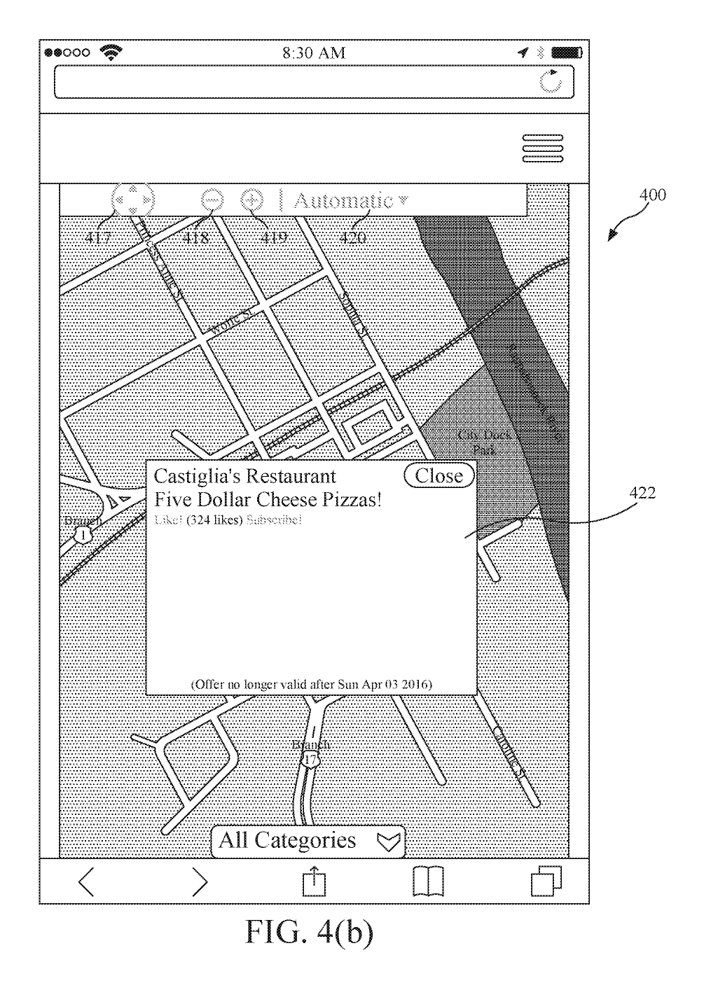

The functions provided by modules M (which can be implemented as a combination of hardware and software to be described in more detail below) are intended, at a high level, to provide both constraints and incentives towards both the business side and the client side of the system 300. For example, as regards the business side of the system 300, one of the modules M enables the business apps 304 to upload time-sensitive, geocoded event messages which will be displayed on a map on one or more client apps 306 when certain conditions are met. An example of this type of display is discussed below with respect to FIG. 4. Another module M is responsible to enforce a time limit associated with that uploaded event message, essentially operating as an expiration time/date for the uploaded message. In this way, system 300 enhances the likely reliability of the content of the uploaded message, as it is significantly more likely that a business owner or employee will follow through on the provision of a service, product, event or other occurrence being advertised by the uploaded message if that offering is scheduled to occur in the near term, e.g., with the next 24 hours, rather than at some point later in time.

Looking at the client side, the system 300 is also provided with various functionality intended to incentivize end users 306 to use the system 300 to find, e.g., services, products and events that they are interested in purchasing or becoming involved with in their local area. For example, by providing users with filterable, time-sensitive information about local events (e.g., live music performances), current locations of mobile businesses (e.g., food trucks), current sales of goods and services, etc., that they can rely upon to be accurate, the system 300 provides users 306 with a single interface for quickly obtaining all of this information without needing to navigate to numerous websites that may or may not have the information that they are seeking. Moreover, system 300 provides users with a quick, easy and intuitive interface to connect with their local communities in a way that was not previously possible. For example, by scanning the local map interface each day, a user can quickly and easily find out what the entire community (or those portions of the community that he or she is interested in) is doing on that particular day. Furthermore, some of the time-sensitive information provided in the time-sensitive, geocoded event messages found on the user's display are intended to incentivize interested users to take action.

An illustrative example of the local map displayed by the client app 306 portion of the system 300 will serve to make these general features of the embodiments more evident and is provided in FIGS. 4(a) and 4(b). Therein, after a user clicks on an icon representing the client app 306 (not shown) on his or her mobile device (or otherwise actuates the client app 306 on any type of device), and (optionally) accepts a request to share her or his location with the server 302, she or he is presented with a map view 400 of her or his local area. The manner in which the local map 400 is served to the client device 306 by the server 302 is described below. The geographical extent of the local area to be displayed can be predetermined within the system 300 to be a fixed value, e.g., two miles around the user's current location, or it can be based on a user-selectable value, e.g., via a slider user interface element (not shown in FIG. 4(a). For example, a user 306 might select a smaller local area, e.g., less than one mile, in a more urban setting or a larger local area, e.g., 20 miles, in a more rural setting, in order to display a desired number of time-sensitive messages associated with his or her desired event information.

Regardless of the geographical extent of the local area to be displayed, the client app 306 will receive data from the server 302 via client interface 305 regarding those geocoded, time-sensitive messages that are stored in the system 300 and are within the local area of the particular client device 306 that sent its location to server 302. This enables the client app 306 to render pins, bubbles or other representative icons 402, 406, 407-412 as overlays on the local map 400 at the location associated with the business or other entity which generated each of the geocoded, time-sensitive event messages. According to one embodiment, icons 402, 406, 407-412 can be rendered on the display using a logo associated with the business or entity which created the corresponding message. According to one embodiment, the client app 306 may optionally also render a circle 404 on the map interface 400 to indicate a locus within which the user is currently located (since GPS accuracy is not itself pinpoint accuracy). Alternatively, circle 404 can be omitted from the display 400. The remaining, numbered user interface elements 414, 416, 417, 418 and 419 shown in FIG. 4(a) will be described later, after the discussion of how the geocoded, time-sensitive event messages themselves are generated and displayed.

The icons 402, 406, 407-412 which are representative of the time-sensitive, geocoded event messages which are displayable within a client app 306's local area may themselves be configured by the app 306 to share no additional information with the user of the client app 306 unless selected by the user (as described below) other than informing the user of the fact that a local, time sensitive event is occurring at the location on the map where the icon is disposed, and that more information is available. Alternatively, according to another embodiment, when a cursor rolls over an icon 402, 406, 407-412, a subset of the full information available in the time-sensitive message associated with that icon can be displayed, e.g., just the name of the business. Still further the icons 402 can be color coded to indicate the time-sensitivity of the text messages associated therewith, e.g., red could indicate a message which will expire within an hour, yellow could indicate a message which will expire in 6 hours and green could indicate a message which will expire within more than 6 hours.

When a user clicks on, or otherwise actuates, an icon representing a time-sensitive, geocoded event message, e.g., icon 402, on the local map 400, the time-sensitive message 422 associated with that particular icon 402 is displayed in an overlaid fashion on the local map display 400. An example of a time-sensitive message 422 according to an embodiment is illustrated in FIG. 4(b). The time-sensitive message 422 can contain a variety of different information elements, some of which are shown in the example of FIG. 4(b). For example, a time-sensitive message 422 according to various embodiments can include one or more of the following fields or information elements:
1. A limited text description (e.g., 150 character) of the time-sensitive information that a business wants to publish to the local community (i.e., the sandwich board text);
2. The name of the business;
3. The category associated with the time-sensitive information or the business, e.g. dining, entertainment, etc.;
4. An end date and/or time for the time-sensitive message (also referred to herein as the message's validity period and/or its expiration time/date)—according to one embodiment a default value for this field is 1 day (day of posting);
5. A physical location associated with the message, e.g. business (default) location, custom address, or current GPS location;
6. A picture of an item being advertised;
7. A link to more information, e.g. Web site, Facebook, Instagram, etc.
8. An event window (a time of an event being advertised by the time-sensitive message)—if this is different than the start/end date of the time-sensitive message itself. For example, the time-sensitive message might be valid for one day, but the event itself being advertised could be a 2 hour concert three days later;
9. A quantity indicator, i.e., how many of the spots, products or services are available;
10. A “likes” indicator; and
11. A subscribe link.
   Other data elements can also be added in support of, e.g., data reliability and/or user interest, some examples of which will be provided below.

In the particular example of FIG. 4(b), it can be seen that the time-sensitive message 422 includes a business name field (“Castiglia's Restaurant”), a description of the time-sensitive event or offering {“Five Dollar Cheese Pizzas”), a “likes” indicator showing that 324 people have liked this message, and an indication that this particular offer is not valid after Sunday, Apr. 3, 2016. Thus, this particular time-sensitive message 422, and its corresponding icon 402, would no longer be visible on local map display 400 on Monday, April 4^{th} (unless renewed by the business owner who initiated this particular time-sensitive message). Various aspects associated with updating, renewing, removing and other management techniques for handling the time-sensitive display of these messages in systems 300 according to various embodiments are further described below. Note that while some of the information found in time-sensitive message 422 can be considered static information, e.g., the business name and address, other information is clearly dynamic, e.g., a text message regarding a live music event that occurs in four hours at a particular music venue. Thus, in the context of some of the embodiments herein, time-sensitive messaging refers both to the fact that the system 300 enforces a certain expiration period of the displayed message itself, and/or that at least some of the information in the displayed message has an inherent time relevance to it.

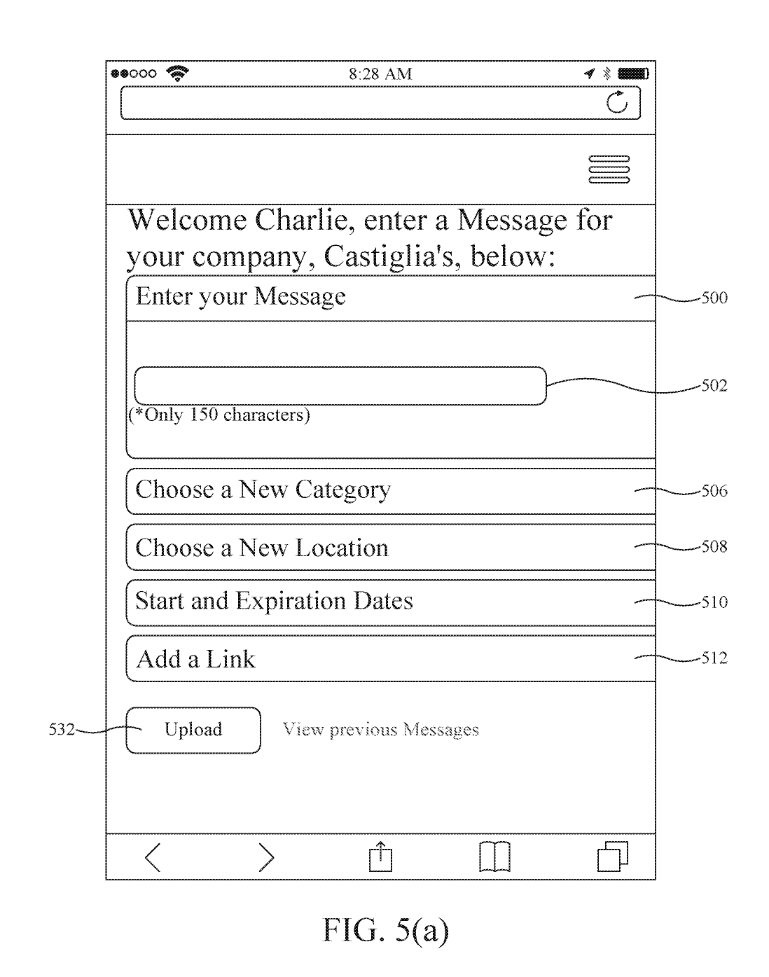

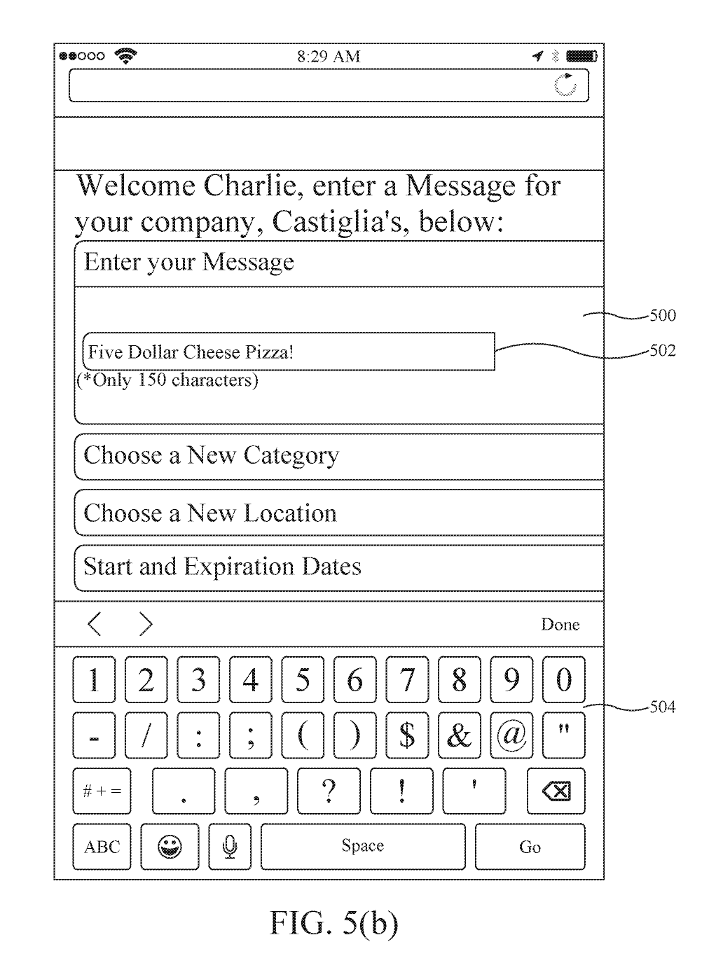

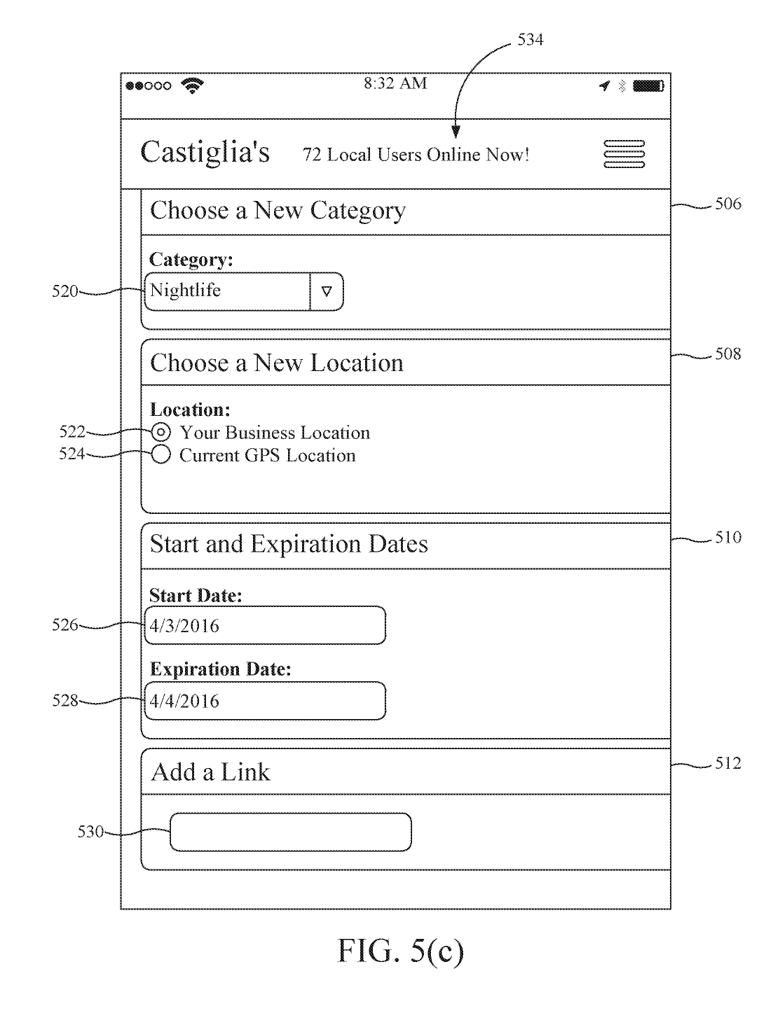

The time sensitivity of the message 422 is, according to an embodiment, enforced by the system 300 but can also be impacted by the manner in which the business app 304 is used to create the time-sensitive message in the system 300. FIGS. 5(a)-5(c) illustrate user interface screens which can be displayed on the computer or mobile device of the business owner/representative who is permitted to enter time-sensitive messages 422 into the system 300 via business app 304. Starting with FIG. 5(a), when the business app 304 is actuated, the business representative can initiate the uploading of a time-sensitive message using screen 500. Therein, to enter a time-sensitive message, the first field from the top of screen 500 is field 502 which enables the business owner/representative to enter the text of the time-sensitive message. According to some embodiments, the number of characters available for entry is limited (e.g., 150 characters as indicated in FIG. 5(a)) so as to be displayable on the client side at a font size that is large enough to easily read, but which will also take up only a small portion of the local map display 400 when it is overlaid thereon.

When the business owner/representative positions the cursor over field 502, a virtual keyboard 504 can be displayed on the screen 500 as shown in FIG. 5(b) to enable the business owner/representative to enter the text to be displayed in the time-sensitive message. The text entered into field 502 can indicate any time-sensitive message that the business wants to convey to the local users of app 306, e.g., a sale, certain products which are now available, a time slot opening up for a service provider, etc. Returning to FIG. 5(a), when the business owner/user navigates to one of the other user interface elements shown on screen 500, i.e., the “Choose a New Category” element 506, “Choose a New Location” element 508, “Start and Expiration Dates” element 510, or “Add a Link” element 512, then the business owner/representative is presented with additional user interface options for entering these characteristics of the time-sensitive message to be uploaded to system 300 as shown, for example, in FIG. 5(c).

Therein, the business owner/representative is presented with a category drop down box 520 which presents a list of time-sensitive message categories from which the business user can select a category (or categories) that characterize the general nature of either their business or the time-sensitive message itself. This category can then be used to filter the icons presented on the local map 400 as will be illustrated below. An exemplary list of categories includes: Automotive, Bars, Clothing/Apparel, Coffee, Community, Cosmetic, Daycare, Dining, Education, Entertainment, Government, Grocery, Healthcare, Housing, Hotel/Hospitality, Jobs, Media, Museum, Nightlife, Online, Religious, Recreation, Retail, Retirement, Special, Spa/Massage, Sports and Yard Sale. Those skilled in the art will appreciate that the category drop down box 520 could include more or fewer categories and that the foregoing list is purely illustrative. Nonetheless, the drop down box 520 (or the like) enables the business user to assign a category to the time-sensitive message 422 that she or he is planning to upload to the server 302. The categories provided for selection in drop down box 520 may be a subset of the total number of categories available (or even only one category) selected, for example, based on the type of business operated by the business user who is creating the time-sensitive message for uploading in order to enhance the reliability of the categorization. For example, a restaurant owner who is creating a time-sensitive message for upload may only be presented with the choices of “Dining” or “Nightlife” in drop down box 520 to enable them to categorize time-sensitive messages related to food specials or live music events, respectively.

According to another embodiment, the server 302 can play a role in message category assignment. For example, server 302 can receive the suggested category assignment from the business user as part of the upload signal (described below) and can evaluate it to determine if it is accurate, e.g., based on the content of the text message itself and/or the nature of the business uploading the message. Alternatively, the server 302 can be solely responsible for category assignment based on these or other criteria.

The business user can also select a location to be associated with the time-sensitive message using interface element 508. In the embodiment of FIG. 5(c), two options are provided, i.e., a selection element 522 which enables selection of the business user's business' location, and a selection element 524 which enables selection of the current GPS location of the device 304 which is being used to create the time-sensitive message for upload. The selection element 522 could be used for most “brick and mortar” businesses where the event being publicized via time-sensitive, geocoded message 422 is something which is occurring at that business' permanent address. Alternatively, selection element 524 could instead be selected when the event being publicized is not occurring at the business' fixed address, e.g., when the business is sponsoring a tent at a local fair or charity event. Additionally, selection element 524 could also be used by either businesses which have no fixed addresses, e.g., food trucks, or businesses which have a mobile component to their businesses, e.g., pet boarding businesses with a mobile pet grooming truck, to indicate a current location of the mobile business or mobile business component as well as the time-sensitive text message associated with that business. The location selected by either button 522 or 524 will indicate the coordinates on the local map display 400 where the icon 402 will be displayed for the time-sensitive message being created after it is uploaded to server 302 during its displayable time period, to be described next. Collection of this data allows the time sensitive message 502 to be geocoded with latitude/longitude coordinates in the database 310 for subsequent searching and display on the local maps 400.

User interface element 510 indicates the start date 526 and end/expiration date 528 for the time-sensitive message. This is the time period during which the time-sensitive message 502 can be viewed on the client apps 306 for users of the client devices 306 that are local to (i.e., within a predetermined distance of) the location associated with the time-sensitive message via radio buttons 522 or 524 described above. According to one embodiment, the business user enters a start date into field 526 and an expiration date into 528, but these fields are constrained by the server 302 to restrict the duration of display of the time-sensitive message, e.g., the start date 526 could be constrained by the server 302 to be either the current day or the next day (in terms of the local time of the business user) and the expiration date 528 could be constrained to be a predetermined time later, e.g., one day. According to one embodiment, time-sensitive messages can be activated/valid for display for a 24 hour period starting at midnight on the start date indicated in field 526. According to another embodiment, the expiration date/times could be user-selectable, e.g., within some predetermined allowable range of dates/times constrained by the server 302.

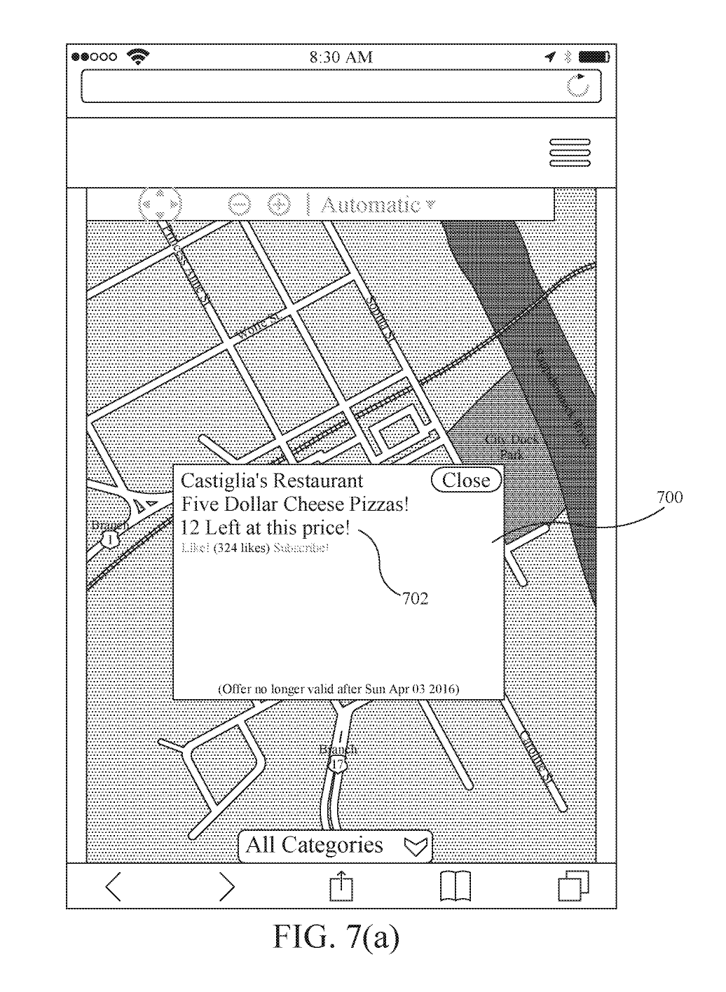

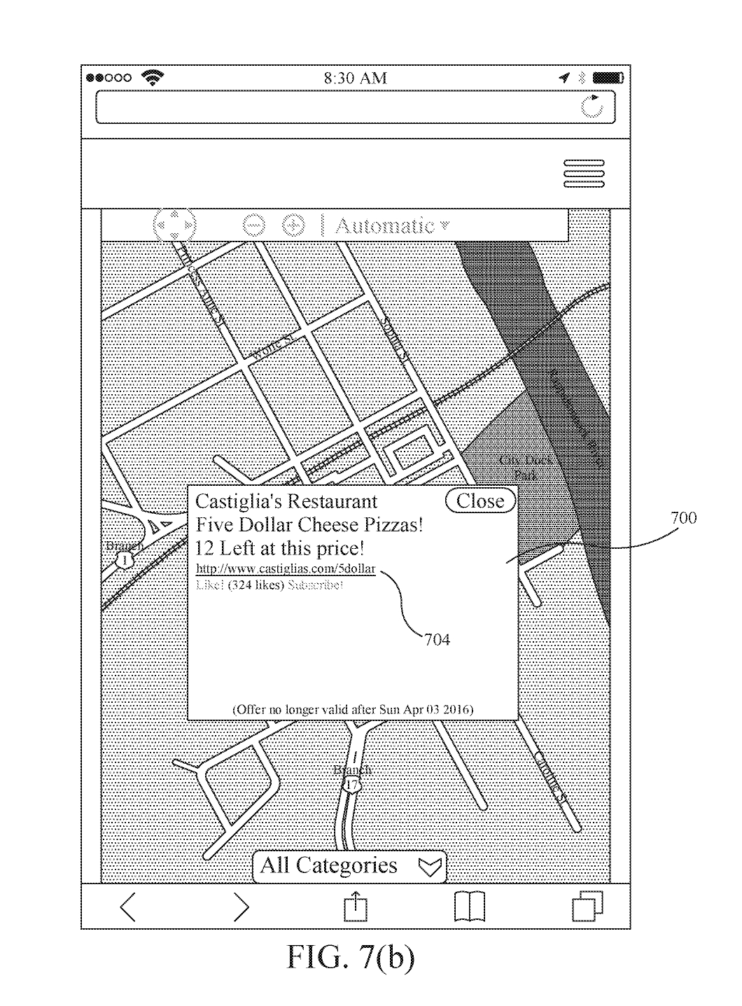

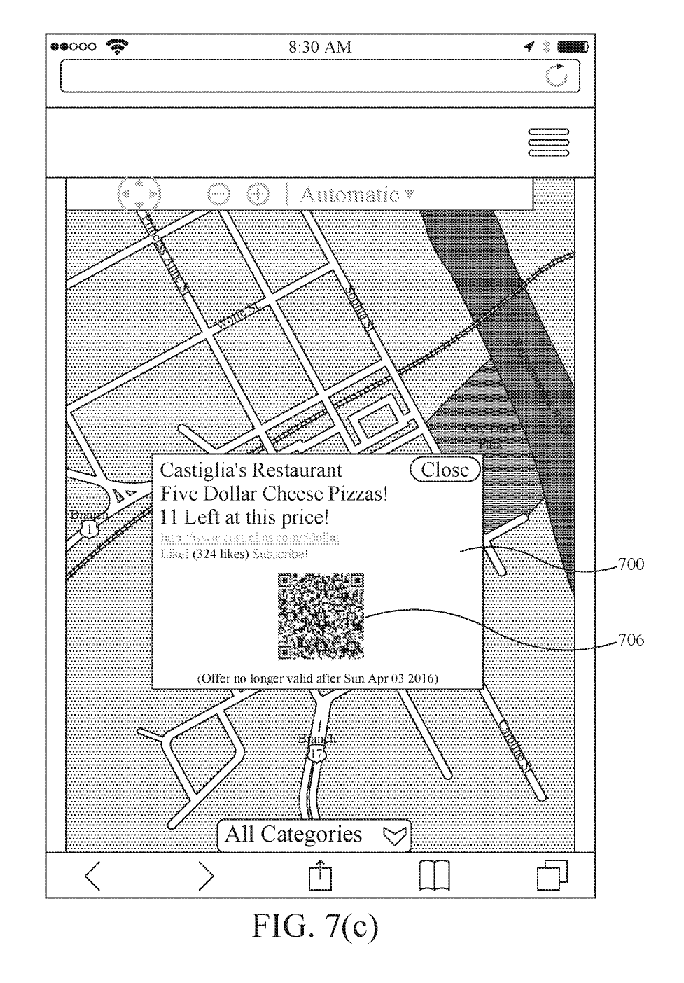

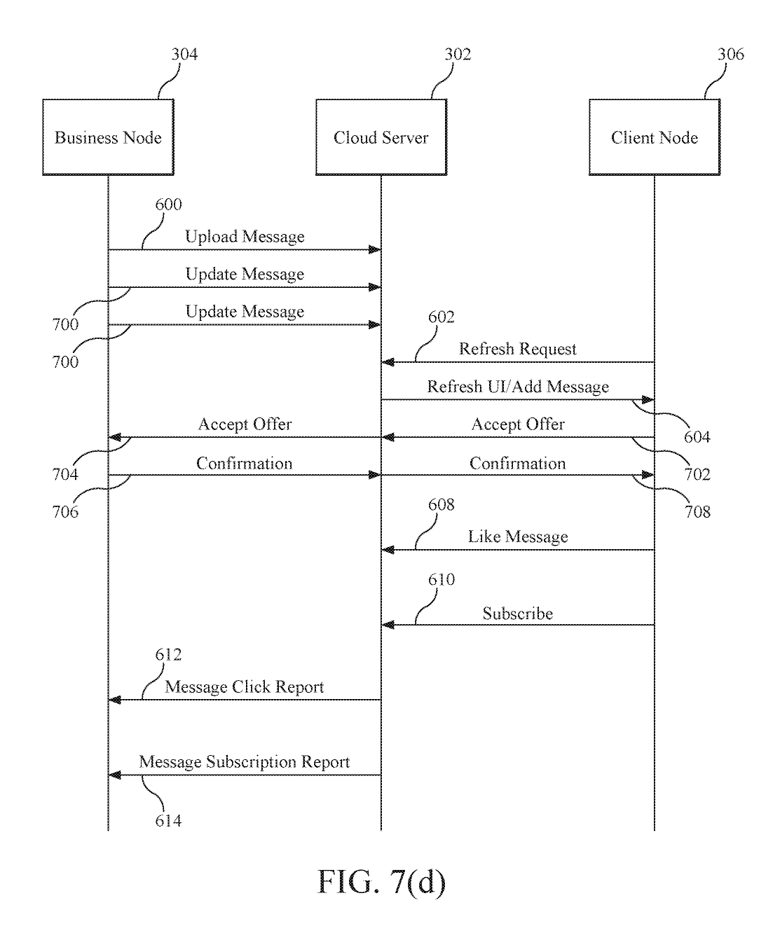

As mentioned earlier, by constraining both the start date and the expiration date of the time-sensitive message, embodiments described herein achieve at least two valuable objectives: (a) the information provided about the event being promoted by the business user is more likely to be reliable for the client users 306 since it is an event which is occurring in the near term and (b) the information is more likely to be acted upon by the client users 306 since there is a certain time-sensitive urgency to the message. Field 512 also offers a text entry box 530 into which the business owner can enter a link, e.g., a URL to their website. Once all of the information described above with respect to FIGS. 5(a)-5(c) has been entered by the business user, the business user can initiate uploading of the time-sensitive message by actuating a user interface element indicating completion of the message, such as button 532 shown in FIG. 5(a). When a business entity 304 is about to submit a time sensitive message 502, the system can show a number of users, i.e. people with the app 306 installed, who are currently within a predetermined local area, e.g., a 2 mile radius, of their business location at that particular time as shown, for example, by the display portion 534 in FIG. 5(c). This information may help business users 304 to tailor their message, e.g., in terms of expiration time and/or quantity limitations as described below with respect to FIGS. 7(a)-7(d).

In addition to the time-sensitive message's start 526 and expiration 528 time and/or date, according to another embodiment a second time window may be available for entry by the business user as part of the entry of a time-sensitive, geocoded event message, which second time window is referred to herein as an “event window”. Whereas the first time window, i.e., the start/expiration window, defines when the time-sensitive message is displayable on the local maps 400 of client apps 306, the event window instead defines a time window which indicates when the event itself is occurring. In some cases, it may be the situation that a business owner wants to advertise a particular event/sale, etc., in advance of the actual time of the event itself, or that the event which is being published is only occurring for a portion of the start/expiration time window. For example, for a live music event which is occurring on Friday night at 9 pm, the business user might want to promote the event on Wednesday or Thursday using a time-sensitive, geocoded message which is displayable on Monday or Tuesday of that same week. Alternatively, the business user might want to publish a lunch special at a restaurant starting at noon on Wednesday using a time-sensitive, geocoded message which is published at 8 am on Wednesday. In these situations, or the like, the provision of a second time window, the event time window (not shown in FIG. 5(c)), enables the business user to enter this second time period for display when presented to client users 306.

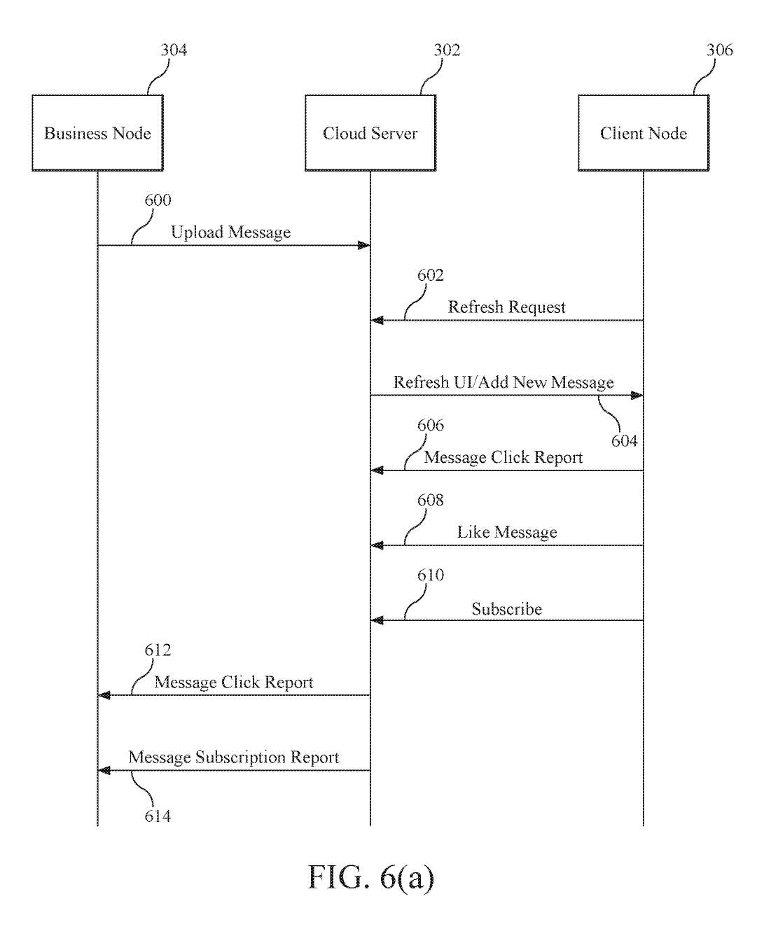

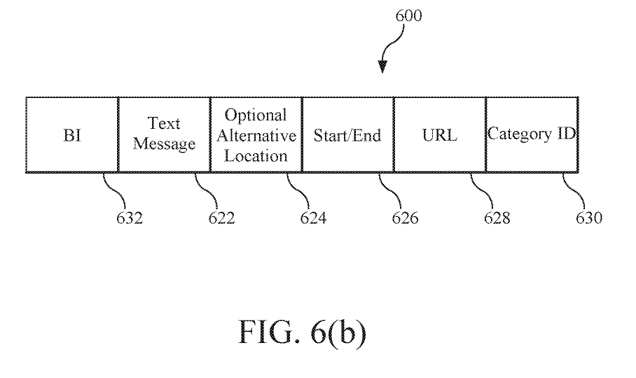

FIG. 6(a) shows a signaling diagram illustrating various signals which are communicated within the system 300 to implement time-sensitive, geocoded event messaging according to an embodiment as described herein. Therein, signal 600 refers to the upload message signal sent from the business node 304 which generated the time-sensitive message, e.g., via the user interface described above with respect to FIGS. 5(a)-5(c), to the server 302, e.g., via the Internet. More specifically, the upload message signal 600 can contain the information associated with the time-sensitive message that was collected from the business user using the business app on node 304 as described above which information is carried in various fields in signal 600 as shown in FIG. 6(b), e.g., via a text message field 622, optional alternate location field 624 (i.e., when the business user selects the option to insert a current location to associate with the time-sensitive message 601 rather than the default location associated with the business itself), start/end field 626 for the message's display duration, an optional URL field 628 and a category ID indicating which category (or categories) the business user suggests as a classifier of the message for filtering purposes on the client side. Also shown is a business identifier field 632 which can be appended to the time-sensitive message 601 to indicate the source of the message to the server 302 (e.g., to ensure that it is a valid business, registered with the system to enhance the reliability of the information to be published by the server 302 to the user apps 306). The business identifier 632 also serves as the geocoding (i.e., indicator of longitude, latitude or other location coordinates which tell the server 302 where to display the icon 402 on the local display map 400) of the time-sensitive message 601 when the optional alternative location field 624 is not used. Alternatively, the business app 304 can instead insert the business 304's default location coordinates when button 522 is selected into field 624 to geocode the signal 600.

Those skilled in the art will appreciate that upload signal 600 can include more or fewer data fields than those shown in FIG. 6(b). For example, upload signal 600 could also include a message identifier field which gives a number to the particular time-sensitive, geocoded message being conveyed in order to distinguish it from others generated by the same business. Upload signal 600 could also include a binary image link to enable a picture to be associated with the text message.

When the time-sensitive message upload signal 600 is received by the cloud server 302, the information in some or all of the fields described above can be stored in a record in a database 310 used to generate the icons 402 and time-sensitive messages 422 by the business side interface of server 302 by an upload management module 800 (shown in FIG. 8). Periodically, the server 302 will receive refresh request signals from various client apps 306, e.g., when a client app 306 is initially launched or when the applied filter(s) on the client app 306 are changed (as described in more detail below), in order to update the client app's local map display 400, e.g., which might change due to a change in the location of the client device 306 and/or due to new time-sensitive messages becoming valid or invalid. The refresh request signal 602 typically includes information indicating a current location associated with the client node 304 and can be generated either periodically, e.g., every 5 seconds by the client node 304, when the client node 304's location has changed by a predetermined amount and/or when a certain user interaction with the app 304 occurs, e.g., a change in filtering criteria.

When the client side interface 305 of the server 302 receives a refresh request signal 602 from a client node 306 due to one of these triggering events, the client side interface 305 determines which valid time-sensitive messages are within the predetermined distance of the client node 306's current location using the received current location of the client node 304 and the stored location information associated with each time-sensitive, geocoded message stored in the database 310, and sends refresh information back to that particular client node 306 via signal 604. This refresh information can be a complete set of icons 402 associated with still valid (in a time sense) messages 422, which have a location within the predetermined distance and which are also associated with a category selected within the client app 306, or it can be a differential signal which transmits only changes for items having those characteristics to the client app 306 relative to a previously transmitted set of data. In addition to the icons 402, the refresh signal 604 can also include all of the additional, more detailed information (e.g., text message, picture, url, etc.) which will be displayed when a user 306 clicks on an icon 402. Although only shown for a single business node 304 and client node 306, those skilled in the art will appreciate that a large number of business nodes 304 and client nodes 306 can be supported by the cloud server 302 in a similar manner. This refresh functionality can be coordinated by a refresh management module 802 illustrated in FIG. 8. According to other embodiments, refresh functionality can be more of a pure push mechanism in the sense that server 302 is periodically pushing time-sensitive message updates to all active client devices 304 based on their current locations.

Generally speaking, and according to some embodiments, the push mechanism described above is used to provide client users with time-sensitive messages 422 and enables client users to review such messages with a high degree of privacy since their personal information, e.g., their presence online, their current location, their text message or email address, etc., is not available to the business users via the business interface 303 of server 302 (unless a client user 306 subscribes in system 300 to a particular business, as will be described below with respect to subscription module 806). However, in order to provide some feedback to the businesses about the interest level generated by their event publication messages, when a client app 306 receives a click on one of the icons 402, indicating that the user wants to read the time-sensitive message 422 associated therewith, this action can trigger the sending of a click report signal 606 from the client node 304 to the server 302 via the client side interface of server 302, or alternatively can be aggregated in a click count to be sent in a click report signal sent periodically, e.g., daily, weekly or monthly. These click reports can be counted and stored in the database along with the time-sensitive message 422 they correspond to and a click report 612 can be transmitted back to the business node 304 which generated that particular time sensitive message 422 indicating the number of clicks that it received. Click report signal 612 can be transmitted, for example, upon demand by the business user/node 304, or upon expiration of the time-sensitive message 422.

As seen, in FIG. 4(b), client app users also have the ability to like a message 422 or subscribe to a business associated with a message 422 via Like! and Subscribe! links. When these links are actuated by a client user 306, they also generate signals 608 and 610, respectively, which are transmitted to the server 302 so that the client side interface can update the like count (stored in database 310), which like count will then be updated in the corresponding time-sensitive message 422 when next refreshed, or initiate a subscription process (described below), including the provision of a subscription report signal 614 to a business node 304 which updates the business regarding new subscribers to its time-sensitive messages.

As mentioned above, time-sensitivity of the published event messages provides benefits in terms of reliability of the information contained in those messages, and the prompting of users to act more urgently on message contents. According to other embodiments, another characteristic or parameter which can be added to messages published using system 300 to further incentivize client users to act on message contents is that of a dynamic quantity limitation. For example, as shown in FIG. 7(a), in addition to indicating a time restriction on a sale on pizzas as shown in FIG. 4(b), a further constraint is added to the time-sensitive message 700, specifically that there are only 12 pizzas available at that price. The displayed quantity number 702, twelve in this example, can be updated by the system 300 to the display of the time-sensitive message on client apps 306, e.g., upon a refresh event, based on sale information provided by the business node 304 to the server 302, so as to show client app users 306 a decrementing quantity value as pizzas are purchased from this vendor as part of the published event.

According to one embodiment, there may be no further interaction available between the client app/user device 306 and the business node 304 as regards the time and quantity limited event published by message 700. According to other embodiments, however, system 300 may provide for additional interactions regarding this event. For example, as shown in FIG. 7(b), a further link 704 can be displayed as part of the time and quantity limited message 700 which enables the user of app 306 to signal to the business 306 that he or she would like to accept the time/quantity limited offer being promoted by message 700 by actuating the link 704. This link actuation results in a signal being transmitted from device 306, back to server 302 and then another signal being sent from the server 302 to the business app 304 which published the message 700.

The manner in which the transaction is concluded once a client app 306 signals that it wants to participate in the time/quantity limited event will vary from embodiment to embodiment, but also potentially within embodiments depending upon the type of event/offer being published. For example, if the client app user 306 happens to also be a subscriber (described below) to the business entity 304 which published the message 700, then that business entity might also have sufficient information (e.g., user's name and credit card information) to perform a sale. Alternatively, as shown in FIG. 7(c), if the business entity 304 has no information about the client app 306's user (which will likely be a common occurrence), then the business entity 304 can instead send a confirmation that the user's request to participate in the event has been registered with the company.

When a quantity limited message 700 reaches the point where the quantity of goods or reservations being offered reaches zero remaining, the message 700 and its corresponding icon 402 will no longer be visible on client app 306's local display map 400. In this way, reliability of the information provided by system 300 is maintained.

According to some embodiments, the usage of quantity limitations on an event offer can be used independently of time/expiration limitations where the quantity limitations are such that the message will naturally expire over a short period of time. However in other embodiments it will still be desirable to provide both quantity and time limitations to ensure that the offer remains valid.

This feature of quantity limitations to virtual sandwich board messages like message 700 are expected to have numerous use cases. Consider, for example, a usage scenario for system 300 in the context of a shopping mall according to another embodiment. In the mall, suppose that all (or most) of the stores, and the smaller kiosks located in the common areas of most malls, are business participants in system 300. In order to draw people to the mall on a given day, one or more of these shops or kiosks can provide offers which are both time-sensitive and quantity sensitive. For example, a book store located in the mall might decide to offer a current best-selling book title, e.g., a newly arrived Harry Potter novel, for 80% off the cover list price for the next 3 hours but only for the next 10 purchasers of the book. Client users having apps 306 operating on their smart phones or tablet devices might wait in the food courts of such shopping malls, periodically refreshing their apps 306 until an offer that they are interested in is published. The stores in the mall might coordinate their offers so that shoppers are encouraged to stay in the mall for extended period of time to await an offer for their desired product/service.

Supporting the additional quantity limited characteristics of the event message publications in the embodiments of FIGS. 7(a)-7(c) may involve additional signaling and signal processing for system 300. For example, as shown in FIG. 7(d), in addition to the signaling described above with respect to FIG. 6(a), quantity update signals 700 will be sent from the business node 304 to the cloud server 302, e.g., as quantity limited products or services associated with a quantity-limited message are sold or otherwise allocated to users. Thus, in the example of FIG. 7(d), an initial quantity field can be added to the data packet illustrated in FIG. 6(b), to indicate to server 302 an initial quantity to be published with the message 700, e.g., 12 in the example of FIG. 7(a). As pizzas are purchased, either directly in response to the offer via QR codes from users or more generally from both users of system 300 and non-users of system 300, the business node 304 will send update signals 700 which decrement a counter or field stored in database 310, such that refreshes of the displayed messages 700 on the client apps 306 will display a more current value of the quantity-limited offering. For example, suppose that after an initial upload of the quantity-limited message 700 via signal 600 that five pizzas had been sold as part of this event prior to a particular client device 306 executing the client app within the predetermined distance of the business Castiglia's, such that this particular client device 306 and its local display map 400 would show the icon 402 and then corresponding message 700. At that time, the message 700 would receive, via signal 604, information indicating the quantity number “5” should be displayed in the part of the UI screen where “12” is displayed in FIG. 7(a). Those skilled in the art will appreciate that there are other techniques which could be used to keep the quantity number current on client apps 306 that are monitoring a given quantity-sensitive message 700. When the server 302 receives an update signal 700 indicating that the last available item has been allocated, i.e., the counter is decremented to zero, the server 302 can invalidate the entire message 700 in the same manner that it would have if the time period expired for its display. Thus, upon refresh, client devices 306 within the predetermined distance of the location assigned to message 700 would no longer have this icon/message combination displayed on their local display map 400.

If the particular implementation of system 300 also provides the functionality reflected in the UI screen of FIG. 7(b), i.e., the capability for a user to claim or accept a particular time/quantity sensitive offer in a message 700, e.g., via an actuatable link 704, then some additional signals are introduced. For example, an accept offer signal 702 can be transmitted from the client node 306 to the client interface of server 302 when the user clicks on link 704 (possibly after a confirmation bubble is displayed to avoid inadvertent clicks). The accept offer signal 702 will include sufficient information for the cloud server 302 to broker a transaction between the particular client node/user 306 which accepted an offer, and a business entity/node 304 which initiated the offer by publishing the time/quantity sensitive message 700. Such information can include, for example, an identity of the client node 306 (which could be a temporary identity assigned to the particular app session which was assigned when the app 306 was launched on the user device, i.e., a temporary identity which cannot be used to identify the actual user of the device 306 but which can be used to direct responsive signaling back to the correct device 306 while the session is active), an identification of the message 700 whose offer is being accepted, and (optionally) a timestamp indicating a time of acceptance.

When server 302 receives an accept offer signal 702, it can process the data provided therein to update a client record in database 310 to setup a pending transaction for later completion and then generate an offer accepted signal 704 for transmission to the business node 304 associated with the message 700. Signal 704 can include an identity associated with this particular transaction, e.g., the temporary identity of the user session assigned to node 306, and a timestamp (e.g., to be used to resolve substantially simultaneous acceptances when quantities run out) and an identifier of the particular message 700 whose offer has been accepted, e.g., to distinguish between potentially multiple messages/offers from the same business entity 304. Upon receipt, business node 304 (which may be a point-of-sale terminal or connected thereto to manage inventory/quantity bookkeeping associated with the quantity limited message 700), will respond with a confirmation signal 706 (or denial signal if quantities already reached zero). If this particular implementation of system 300 provides for a specific type of user portable confirmation, e.g., a QR code 706 or the like, then that data will be provided in signal 706 to the server 302 so that it can be forwarded to the appropriate client node 306 via confirmation signal 708. Otherwise, signal 706 can include a binary accept/deny field, indicating whether the business entity 304 was able to fulfill the order, as well as the business entity ID and transaction ID which the business node 304 received in signal 704.

Returning now to FIG. 4(a), the user interface displayed on a client device 306 offers other interaction options in addition to the display of the representative icons and corresponding time-sensitive, geocoded event messages which have been discussed above. Specifically, numbered user interface elements 414, 416, 417, 418 and 419 shown in FIG. 4(a) provide various additional functionality to the business 304 and/or client 306 apps according to various embodiments. For example, user interface element 414 can provide a general menu of options for the user, e.g., a link to reach the time-sensitive message creation screen of FIG. 5(a), a link to an account management screen, etc. Filter drop down element 416 enables the user to select one or more of the categories described above to filter the display of icons on the local map 400. For example, if a user was to select user interface element 416, a scrollable list of the categories which can be assigned to the time-sensitive messages is presented from which the user can select one or more of the categories. When a new filtering category is selected, the user app 306 sends a signal to the client side interface 305 requesting a refresh of its local map 400 with those icons 402 which correspond to time-sensitive messages 422 that have the identified category (and which are within the predetermined area around the client device 306). The server 302 will then return a signal with the filtered time-sensitive messages, which can then be rendered on the client app 306's local map 400.

User interface elements 417-420 are map navigation controls which enable a user to pan the display, zoom out, zoom in and select the type of map to be displayed (e.g., map view, actual image view, etc.). According to some embodiments, when the local map is panned or zoomed, the server 302 also refreshes the icons 402 and corresponding messages associated with those icons which are displayable based on their corresponding geocoded locations in the newly visible parts of the local map 400.

FIG. 8 depicts central server 302 and some of the logic modules which can be used to implement the afore-described functionality of time and/or quantity sensitive, geocoded event message publication according to various embodiments. For example, upload management module 800 and refresh management module 802 handle the functionality which has already been described above with respect to the actions taken by the server 302 upon receipt of an upload signal 600 or a refresh request signal 602, respectively.

The subscription management module 804 offers another set of functionality which may be made available according to another embodiment. For users 306 that are particularly interested in receiving time-sensitive, geocoded messages from a particular business (or category of businesses), those users 306 can subscribe to a business by clicking on the “Subscribe” link displayed on the time-sensitive, geocoded message, resulting in the transmission of a subscribe signal 610 being sent back to the server 302. When that now subscribed-to business app 304 publishes a new time-sensitive, geocoded event message, the subscription management module 804 will inform subscribed users 306 of that message. The manner in which this informing occurs can vary from implementation to implementation. For example, if the subscribed user 306 has his or her client app active, then the subscription management module 804 can send a message indicating such to the subscribed user 306 which is shown on his or her device, e.g., as an overlay to the local map 400. This new message display can occur even if the subscribed-to business event message is geocoded to a location which is outside of the predetermined local area currently being displayed on the subscribed user 306's local map display.

Time management module 806 can handle, for example, aspects of the embodiments associated with removing time-sensitive messages from the database 310 when their expiration times occur. Similarly, quantity management module 808 can handle, for example, aspects of the embodiments associated with removing quantity-sensitive messages from the database 310 when their associated quantities are reduced to zero and/or to handle handshaking between client users and business users associated with quantity related reservations or transactions, as described above.

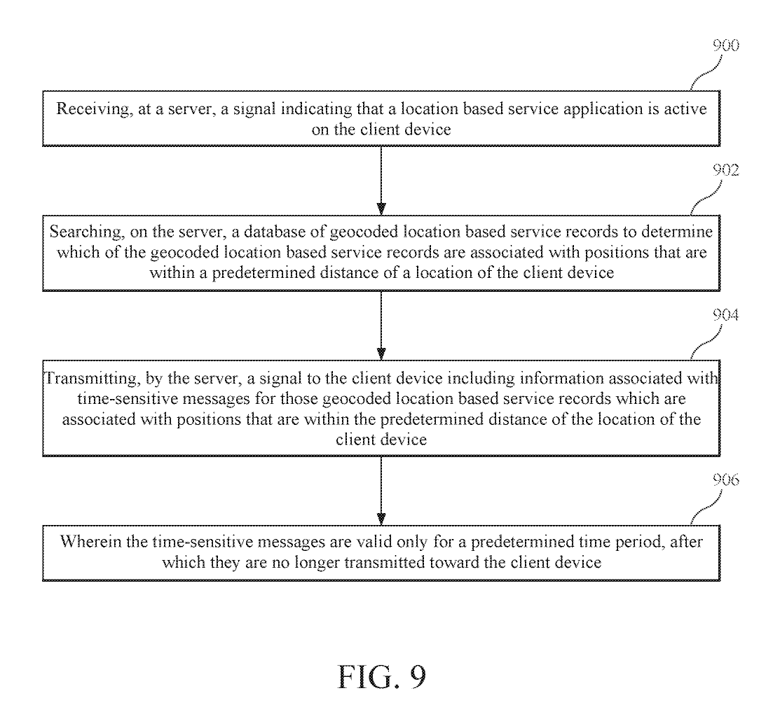

Embodiments described herein can also be expressed as methods, e.g., methods providing location based services to a client device, an example of which is provided in the flowchart of FIG. 9. Therein, at step 900, a signal is received at a server indicating that a location based service application is active on the client device. In this context, “active” can mean that any refresh triggering event has occurred, e.g., when the application is initially launched, when the category filter is changed or when the client app user 306 requests a refresh of the local map 400. In response to receiving this signal, the server searches a database of geocoded location based service records to determine which of the geocoded location based service records are associated with positions that are within a predetermined distance of a location of the client device which sent the signal as indicated by step 902.

At step 904, the server transmits a signal to the client device including information associated with time-sensitive messages for those geocoded location based service records which are associated with positions that are within the predetermined distance of the location of the client device. As indicated by step 906, these time-sensitive messages are valid only for a predetermined time period, after which they are no longer transmitted toward the client device.

The foregoing embodiments can also incorporate i-beacon or proximity beacon technologies. Briefly, i-beacons are low powered, proximity transmitters which emit unique identification signals or values using Bluetooth Low Energy (BLE) technology. A user device can run one or more applications (apps) each of which are configured to listen for one or more of the unique identification signals emitted by i-beacons and to trigger an action when a unique i-beacon ID is received that matches its search criteria. These proximity beacons are presently used by retail stores in malls to sell products to potential customers who are within range. For example, a user with an i-beacon app for his or her favorite shoe store running on his or her cellphone or tablet device, might be informed when he or she comes into range of an i-beacon for that store of a particular sale event that is available to that customer.

Moreover, although some embodiments described above suggest a system which provides a single local map interface which enables various different types of businesses and organizations to publish time-sensitive messages to client users, those skilled in the art will appreciate that other embodiments or implementations could be more focused. For example, a car company, e.g., Tesla, could develop a dedicated application using similar techniques to those described above to enable users to view a map display, either on their portable devices or on a display mounted in their car, which showed where electric charging stations were located for their electric vehicles and to provide other time-sensitive or quantity sensitive information about those electric charging stations, e.g., current price per kWh or the current number of charging bays which are available. As the car is moving the display can be periodically/continuously updated with new charging station icons and their corresponding messages.

Not all of the steps of the techniques described herein are necessarily performed in a single microprocessor or even in a single module.

Additionally, in some embodiments the non-limiting term client device or equipment is used and it refers to any type of wireline or wireless devices communicating with a network node in a cellular or mobile communication system over radio interface. Examples of client devices or user equipments (UEs) are target devices, device to device (D2D) UEs, proximity-based service (ProSe) UEs, machine type UEs or UEs capable of machine to machine communication (aka category 0 UEs, low cost and/or low complexity UEs), PDAs, iPADs, tablets, mobile terminals, smart phones, laptop embedded equipment (LEE), laptop mounted equipment (LME), USB dongles, wireless devices etc. However such devices can also include virtual reality equipments, including VR goggles, headsets, glasses and the like.

It should be understood that this description is not intended to limit the invention. On the contrary, the embodiments are intended to cover alternatives, modifications and equivalents, which are included in the spirit and scope of the invention. Further, in the detailed description of the embodiments, numerous specific details are set forth in order to provide a comprehensive understanding of the invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A radiocommunication system comprising:
a first plurality of computing devices each including a first interface for entering information associated with creation of a time-sensitive, geocoded event message and for uploading the time-sensitive, geocoded event message;
a central server configured to store and process the uploaded time-sensitive, geocoded event messages received via the Internet from the first plurality of computing devices and to generate local map displays which include icons associated with said time-sensitive, geocoded event messages; and
a second plurality of wireless computing devices each of which are configured to execute an application that receives and displays one of the local map displays generated by the central server;
wherein the one of the local display maps which is displayed on a particular one of the second plurality of wireless communication devices includes icons associated with the time-sensitive, geocoded event messages for events which are occurring within both a predetermined time period and within a predetermined distance of a current location of that particular one of the second plurality of wireless communication devices.

2. The radiocommunication system of claim 1, wherein the time-sensitive, geocoded event messages each include an expiration date and/or time, a location associated with the event message and a text event message, all of which are stored by the central server in a record associated with the particular one of the first plurality of computing devices which generated the time-sensitive geocoded event message in a database.

3. The radiocommunication system of claim 2, wherein the central server is further configured to generate one of the local map displays upon receipt of a signal from one of the second plurality of wireless computing devices by searching the database to identify records having stored locations that are within a predetermined distance of a location of the one of the second plurality of computing devices which sent the signal and by placing icons on the one of the local map displays at the identified stored locations.

4. The radiocommunication system of claim 2, wherein central server invalidates a record when its stored expiration date and/or time is reached such that a corresponding icon is no longer displayed on the local map displays.

5. A method for providing location based services to a client device, the method comprising:
receiving, at a server, a signal indicating that a location based service application is active on the client device;
searching, on the server, a database of geocoded location based service records to determine which of the geocoded location based service records are associated with positions that are within a predetermined distance of a location of the client device;
transmitting, by the server, a signal to the client device including information associated with time-sensitive messages for those geocoded location based service records which are associated with positions that are within the predetermined distance of the location of the client device,
wherein the time-sensitive messages are valid only for a predetermined time period, after which they are no longer transmitted toward the client device.

6. A method for providing location based services to a client device, the method comprising:
receiving, at a server, a signal providing a location associated with the client device;
searching, on the server, a database of geocoded, location based service records to determine which of the geocoded location based service records are associated with positions that are within a predetermined distance of the location of the client device;
transmitting, by the server, a signal toward the client device including displayable text information associated with time-sensitive messages for those geocoded location based service records which are associated with positions that are within the predetermined distance of the location of the client device, and
wherein the time-sensitive messages are valid only for a predetermined time period, after which they are no longer transmitted toward the client device.

7. The method of claim 6, wherein the predetermined distance is a default distance fixed in the server.

8. The method of claim 6, wherein the predetermined distance is a user selectable distance within a predetermined range, and wherein the signal received by the server including the location of the client device also includes the user selectable distance.

9. The method of claim 6, wherein the predetermined time period is a default time period fixed in the server.

10. The method of claim 6, wherein the predetermined time period is a user selectable time period within a predetermined range.
